(19) United States
(12) Patent Application Publication
(10) Pub. No.: US 2007/0117474 A1
(43) Pub. Date: May 24, 2007

(54) Signal pin of switches

(75) Inventors: Chin-Wen Chou, Taipei Hsien (TW); Tsui-Jung Su, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/282,676

(22) Filed: Nov. 21, 2005

(51) Int. Cl. H01R 13/02

(52) U.S. Cl. 439/884

(57) ABSTRACT

A signal pin of switches is extended outside from the interior of a switch and has a bend surface and a force receiving surface. The bend surface has an indented bend section which has an inner end spot to divide the signal pin into a bracing arm portion and a bending portion. The first torque between the inner end spot and the bend surface of the bending portion is greater than the second torque between the inner end spot and the bend surface of the bracing arm portion. Therefore the signal pin can be easily bent by an external force.

### FIELD OF THE INVENTION

The present invention relates to a signal pin of switches and particularly to a bending technique to bend signal pins of switches to facilitate insertion of the signal pins in a circuit board or performing of SMD process.

### BACKGROUND OF THE INVENTION

With advance of technology, the size of electronic devices (such as mouse) becomes smaller. The electronic elements used on those smaller electronic devices also have to be miniaturized. A great portion of these electronic elements are switches. While micro switches are available now, to achieve a desired connection click during depressing is still difficult for the present techniques of fabricating the micro switches.

Beside the click, design of the signal pin also is one of the factors affecting accurate signal output of the switch. In the conventional switch design, the signal pin is mostly exposed vertically from the bottom of the switch. The circuit board for holding the switch has a hole corresponding to the signal pin. After the signal pin has been inserted into the corresponding hole, it is anchored by soldering. As the electronic devices are being miniaturized gradually, the interior space is limited. The space available for installing the circuit board also decreases. As a result, interference occurs among the electronic elements due to not sufficient installation space. To mitigate this problem, many switches adopt a vertical installation mode to replace the traditional transverse installation mode to save installation space of the circuit board. This issue is especially keen in the SMD (Surface Mount Device) manufacturing process. The signal pin of the switch usually has a lengthy exposed portion that affects installation of other electronic elements. Hence a bending process is needed for the signal pin. Due to the signal pin is quite fragile, to bend directly by an external force easily breaks or deforms the signal pin at the exposed end. Even if the bending were done smoothly, the bending could still be not sufficient and result in assembling difficulty of the switch.

### SUMMARY OF THE INVENTION

Therefore the primary object of the present invention is to solve the aforesaid disadvantages. The invention provides a signal pin structure that can be bent easily. The signal pin according to the invention is extended outside from the interior of a switch and has a bend surface and a force receiving surface. The bend surface has an indented bend section which has an inner end spot to divide the signal pin into a bracing arm portion and a bending portion. The torque between the inner end spot and the bend surface of the bending portion is greater than the torque between the inner end spot and the bend surface of the bracing arm portion. Due to the torque of the applying force is greater than that of the receiving force, the signal pin can be easily bent to a selected angle by the external force without twisting, deforming or fracturing.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the signal pin of the invention before being bent.

FIG. 2A is a plane view of the signal pin of the invention before being bent.

FIG. 2B is a fragmentary enlarged view of the signal pin of the invention before being bent.

FIGS. 3A and 3B are schematic views of the signal pin of the present invention in bending operation.

FIG. 4 is a perspective view of the signal pin of the present invention after bent.

### DETAILED DESCRIPTION OF THE PREFERRED EMBODIMENT

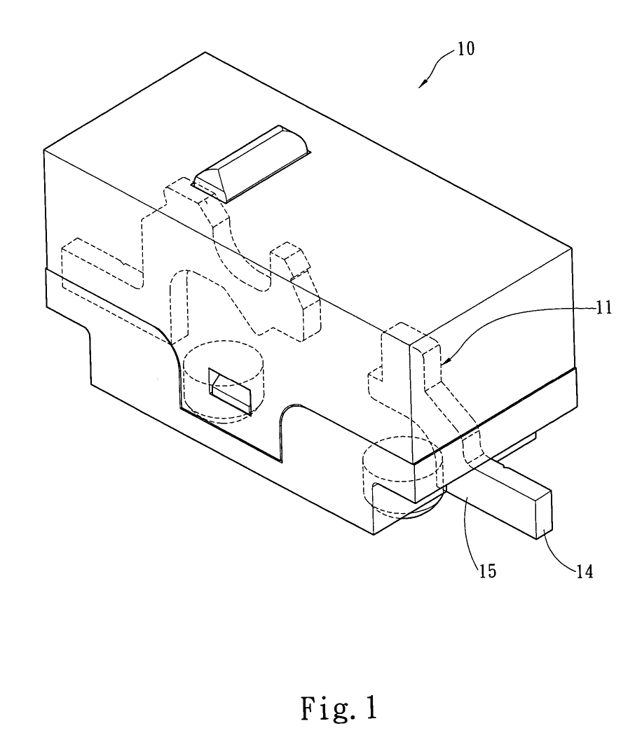

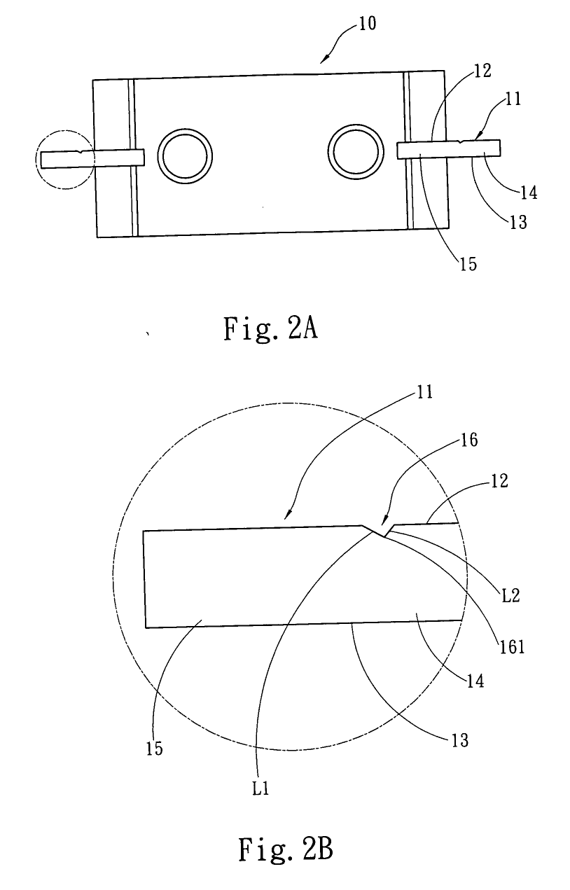

Please refer to FIGS. 1, 2A and 2B for a signal pin 11 of the invention before being bent. The signal pin 11 is extended outside from the interior of a switch 10, and has a bend surface 12 and a force receiving surface 13 opposing the bend surface 12. The bend surface 12 has an indented bend section 16 which has an inner end spot 161 to divide the signal pin 11 into a bracing arm portion 15 and a bending portion 14. The first torque L1 between the inner end spot 161 and the bend surface 12 of the bending portion 14 is greater than the second torque L2 between the inner end spot 161 and the bend surface 12 of the bracing arm portion 15.

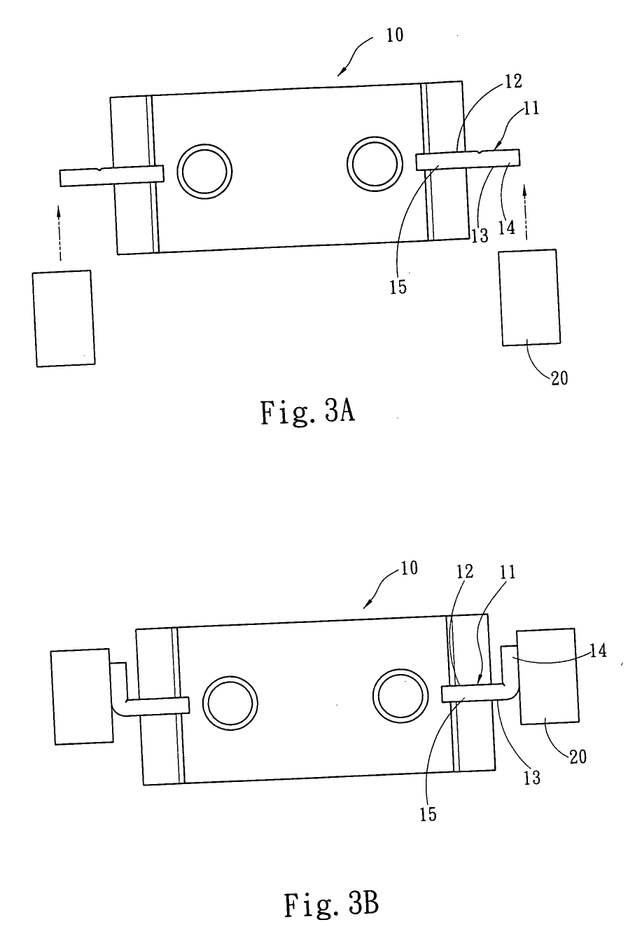

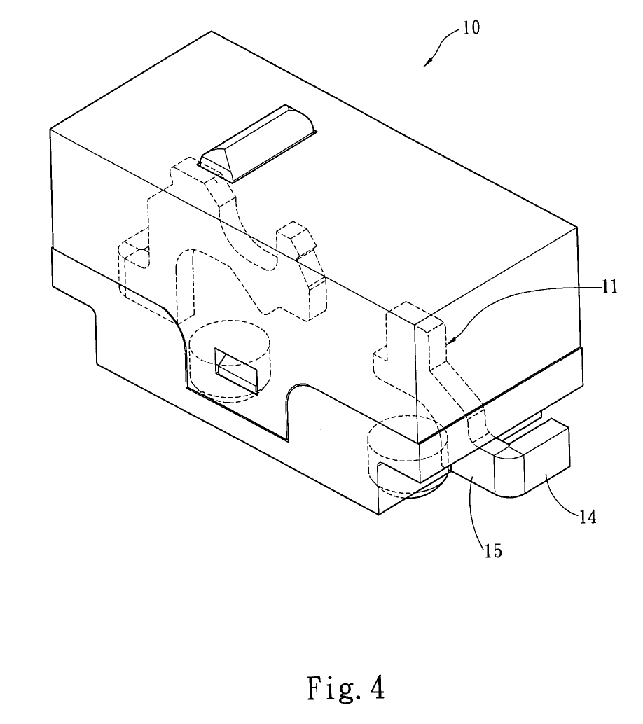

Also refer to FIGS. 3A and 3B for bending operation of the signal pin 11. When an external force 20 is applied on the bending portion 14 of the signal pin 11, the bending portion 14 is bent about the inner end spot 161 towards the bracing arm portion 15. As the first torque L1 caused by the applying force on the bending portion 14 is greater than the second torque L2 resulting from the receiving force on the bracing arm portion 15, the bending portion 14 is easily bent towards the bracing arm portion 15 without producing twist, deformation or fracturing. Moreover, the external force 20 can also easily bend the bending portion 14 towards the bracing arm portion 15 to a selected angle as shown in FIG. 4.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A signal pin of switches extended outside from the interior of a switch, comprising:
a surface defined into a bend surface and a force receiving surface opposing the bend surface, the bend surface having an indented bend section which has an inner end spot to divide the signal pin into a bracing arm portion and a bending portion, the first torque between the inner end spot and the bend surface of the bending portion being greater than the second torque between the inner end spot and the bend surface of the bracing arm portion.
